(19) United States
(12) Patent Application Publication
(10) Pub. No.: US 2025/0198859 A1
(43) Pub. Date: Jun. 19, 2025

(54) METHOD, DEVICE AND EQUIPMENT FOR DETECTING AXIAL PIPE STRESS BASED ON ORTHOGONAL ALTERNATING ELECTROMAGNETISM

(71) Applicant: CHINA OIL & GAS PIPELINE NETWORK CORPORATION, Beijing (CN)

(72) Inventors: Pengchao CHEN, Beijing (CN); Rui LI, Beijing (CN); Kuan FU, Beijing (CN); Hao LAN, Beijing (CN); Jianfeng ZHENG, Beijing (CN); Yanan WANG, Beijing (CN)

(73) Assignee: CHINA OIL & GAS PIPELINE NETWORK CORPORATION, Beijing (CN)

(21) Appl. No.: 18/849,537

(22) PCT Filed: Aug. 25, 2023
(86) PCT No.: PCT/CN2023/114817

§ 371 Date: Sep. 23, 2024

(30) Foreign Application Priority Data
Dec. 22, 2022 (CN) 202211657402.X

(51) Int. Cl. G01L 1/12

(52) U.S. Cl. CPC G01L 1/127

(57) ABSTRACT

A method for detecting an axial pipe stress based on the orthogonal alternating electromagnetism (OAE) includes: acquiring a material of the pipe to be detected and determining an excitation intensity corresponding to the pipe to be detected according to the material of the pipe to be detected; generating an alternating magnetic field on the surface of the pipe to be detected by a high-frequency alternating current output by an OAE stress probe in a system for detecting the axial pipe stress based on the OAE according to the excitation intensity; magnetizing the surface of the pipe to be detected according to the alternating magnetic field; and when the variation range of the magnetized alternating magnetic field is smaller than the set range, determining the axial pipe stress of the pipe to be detected by the system for detecting the axial pipe stress based on the OAE.

### CROSS REFERENCE TO THE RELATED APPLICATIONS

This application is the national phase entry of International Application No. PCT/CN2023/114817, filed on Aug. 25, 2023, which is based upon and claims priority to Chinese Patent Application No. 202211657402.X, filed on Dec. 22, 2022, the entire contents of which are incorporated herein by reference.

### TECHNICAL FIELD

The disclosure relates to the technical field of oil and gas pipe detection, in particular to a method, a device and equipment for detecting an axial pipe stress based on the orthogonal alternating electromagnetism (OAE).

### BACKGROUND

The laying position of long-distance oil and gas pipelines is not always constant, it often moves. There may be several reasons for pipe movement, including ground subsidence, rain wash/flood, frost heave and thaw settlement, landslide, earthquake and human activities near the pipeline. Motion and deformation of the pipe redistributes axial stresses in the pipe, causing a longitudinal tensile at some locations and compression in other areas. Consequently, pipelines subject to ground movement experience large longitudinal tensile and/or compressive stresses and strains. In addition, longitudinal strains may occur in a pipe due to the effects of construction and operation, such as pipe casing, internal pressure and temperature. The generation of these large strains may be coupled with the defects and cracks existing in the pipe body, resulting in failure of the pipe body. In severe cases, dangerous events such as explosion will occur, which will seriously affect energy supply and the lives of residents around the pipeline.

The pipeline strain assessment is an important part of the pipeline integrity management in areas with unstable ground conditions. Strain-based integrity assessment is performed by comparing the strain capacity of a pipe with the strain demand (the level of elongation or compression due to external and internal factors). At present, the bending strain of pipes can be well detected by conventional Inertial Measurement Unit (IMU) in-line detection, but there is no effective and rapid online detection method and technology for the pure axial part of longitudinal strain.

At present, the stress measurement of buried pipes is mainly based on the external detection of pipes after excavation, such as the ultrasonic stress measurement. The monitoring method is mainly to monitor the stress-strain of pipes by pasting strain gauges or grating strain gauges. However, the above method can only detect or monitor local points of a pipe, and cannot quickly and effectively detect the stress-strain level of the whole pipeline to ensure that the pipeline is in a safe operation state.

Based on this, it is necessary to propose a system and a method for detecting the axial stress with a high detection rate, fast speed and covering the whole pipeline in view of the above technical problems, so as to quickly detect the axial stress of oil and gas pipes under the combination of geotechnical engineering hazards, temperature effects, soil constraint conditions and internal pressure effects.

### SUMMARY

The technical problem to be solved by the present disclosure is to provide a method, a device and equipment for detecting an axial pipe stress based on the orthogonal alternating electromagnetism (OAE), aiming at solving at least one of the above-mentioned technical problems, specifically as follows:

1) In a first aspect, the disclosure provides a method for detecting the axial pipe stress based on the OAE, and the specific technical solution is as follows:

acquiring a material of the pipe to be detected and determining an excitation intensity corresponding to the pipe to be detected according to the material of the pipe to be detected;

generating an alternating magnetic field on a surface of the pipe to be detected by a high-frequency alternating current output by an OAE stress probe in a system for detecting the axial pipe stress based on the OAE according to the excitation intensity;

magnetizing a surface of the pipe to be detected according to the alternating magnetic field; and

when the variation range of the magnetized alternating magnetic field is smaller than a set range, determining the axial pipe stress of the pipe to be detected by the system for detecting the axial pipe stress based on the OAE.

The method for detecting the axial pipe stress based on the OAE provided by the present disclosure has the following beneficial effects:

generating an alternating magnetic field on a surface of the pipe to be detected by a high-frequency alternating current output by an OAE stress probe in a system for detecting the axial pipe stress based on the OAE. The alternating magnetic field magnetizes the surface of the pipe to be detected, which will change the magnetic field on the surface of the pipe to be detected, and then based on the change of the magnetic field, the axial pipe stress of the pipe to be detected can be detected. The solution of the present application has the advantages of high detection rate, fast speed, covering the whole pipeline, etc. By carrying an in-line detection robot (the system for detecting the axial pipe stress based on the OAE), the stress-strain level of the whole oil and gas pipeline can be quickly detected, providing an effective means for finding and repairing stress-concentrated parts.

On the basis of the above solution, the method for detecting the axial pipe stress based on the OAE in the present disclosure can be improved as follows.

Further, the OAE stress probe includes an excitation coil and a detection coil; the excitation coil includes an axial excitation coil and a circumferential excitation coil, and the axial excitation coil is placed in accordance with an axial direction of the pipe to be detected; the detection coil includes an axial detection coil and a circumferential detection coil, the axial detection coil is placed in accordance with an axial direction of the pipe to be detected; and

the alternating magnetic field includes an axial alternating magnetic field and a circumferential alternating magnetic field.

The beneficial effect of adopting the above further solution is that the axial and circumferential stress detection of the pipe to be detected can be realized through the probe composed of the excitation coil and the detection coil.

Further, a circuit corresponding to the above-mentioned excitation coil includes an oscillator, a first power supply and a variable resistor; a first end of the oscillator is connected with the first power supply, a third end and a sixth end of the oscillator are grounded, a fifth end of the oscillator is connected with the variable resistor, the variable resistor is connected with the first power supply, and a second end of the oscillator outputs a corresponding high-frequency alternating current adjusted by the variable resistor.

The beneficial effect of adopting the above further solution is that the principle of the circuit structure is simple, and it is convenient to quickly generate accurate high-frequency alternating current.

Further, the circuit corresponding to the above-mentioned detection coil includes a second power supply, a third power supply, a first resistor, a second resistor, a third resistor, a fourth resistor, a fifth resistor, a capacitor, a first amplifier and a second amplifier;

a first end of the detection coil is connected with one end of the first resistor, the other end of the first resistor is connected with a negative end of the first amplifier, a second end of the detection coil is connected with one end of the second resistor, the other end of the second resistor is connected with a positive end of the first amplifier, and the negative end of the first amplifier is connected with one end of the third resistor;

the other end of the third resistor is connected with one end of the fifth resistor, the other end of the fifth resistor is connected with a positive end of the second amplifier, a common end between the other end of the fifth resistor and a positive end of the second amplifier is connected with one end of the capacitor, the other end of the capacitor is grounded, one end of the fourth resistor is connected with a negative end of the second amplifier, and the other end of the fourth resistor is connected with an output end of the circuit corresponding to the detection coil.

The beneficial effect of adopting the above further solution is that the principle of the circuit structure is simple, and the accurate axial stress and circumferential stress can be detected quickly.

Further, the above method further includes:

determining a penetration depth corresponding to the pipe to be detected according to the high-frequency alternating current.

The beneficial effect of adopting the above further solution is that the penetration depth represents the magnetized penetration depth, and a greater penetration depth indicates a deeper magnetized penetration depth, so the corresponding alternating electromagnetic detection depth is also larger. If the penetration depth is smaller, the detection depth is smaller. Since the penetration depth generated by the alternating electromagnetism will be related to the excitation frequency, in order to make the stress measurement more accurate, it is necessary to select an appropriate excitation frequency, then, according to the determination of penetration depth, the excitation frequency corresponding to the material of the pipe to be detected can be determined more accurately.

Further, the above-mentioned system for detecting an axial pipe stress based on the OAE further includes two demagnetizers, which are respectively placed at a front end and a rear section of the OAE stress probe.

The beneficial effect of adopting the above further solution is that a part of residual magnetism will remain in the pipe body, which will also lead to an inconsistent magnetic field environment generated during the axial stress detection. By providing two demagnetizers, the external magnetic field of the pipe during the stress probe detection can be identified.

Further, the above-mentioned OAE stress probe includes a plurality of stress probes, each of which is provided in different directions of the pipe section of the pipe to be detected, and the method further includes:

acquiring an axial pipe stress and a circumferential pipe stress in the area corresponding to each of the stress probes through each of the stress probes.

The beneficial effect of adopting the above further solution is that since the area through which a single probe passes cannot cover the entire cross section of the pipe, it is necessary to place multiple probes on the cross section of the pipe at the same time to detect the whole pipeline and realize the stress detection of the whole pipeline to be detected.

2) In a second aspect, the disclosure provides a device for detecting the axial pipe stress based on the OAE, including:

an excitation intensity determination module, for acquiring a material of the pipe to be detected and determining an excitation intensity corresponding to the pipe to be detected according to the material of the pipe to be detected;

an alternating magnetic field generating module, for generating an alternating magnetic field on a surface of the pipe to be detected by a high-frequency alternating current output by an OAE stress probe in a system for detecting the axial pipe stress based on the OAE according to the excitation intensity;

a magnetizing module, for magnetizing a surface of the pipe to be detected according to the alternating magnetic field; and

an axial stress determining module, when the variation range of the magnetized alternating magnetic field is smaller than the set range, for determining the axial pipe stress of the pipe to be detected by the system for detecting the axial pipe stress based on the OAE.

3) In a third aspect, the disclosure further provides an electronic equipment including a memory, a processor and a computer program stored in the memory and capable of running on the processor. When the processor runs the computer program, any of the above-mentioned method for detecting an axial pipe stress based on the OAE is realized.

4) In a fourth aspect, the disclosure further provides a computer-readable storage medium having stored thereon a computer program. When the computer program is run by the processor, any of the above-mentioned method for detecting an axial pipe stress based on the OAE is realized.

5) In a fifth aspect, the disclosure further provides a method for detecting the axial pipe stress based on the OAE, and the specific technical solution is as follows:

determining an optimal excitation intensity corresponding to the pipe to be detected according to the material of the pipe to be detected, and determining an excitation frequency according to an expected magnetized penetration depth;

generating an alternating magnetic field on the surface of the pipe to be detected by using a high-frequency alternating current according to the optimal excitation intensity and the excitation frequency corresponding to the pipe to be detected, so as to magnetize the surface of the pipe to be detected; and

detecting the axial pipe stress of the pipe to be detected when the range of the alternating magnetic field generated on the surface of the pipe is smaller than a range of the stress generated by a deformation.

6) In a sixth aspect, the disclosure further provides a system for detecting the axial pipe stress based on the OAE, and the specific technical solution is as follows:

including a data control and acquisition system and an OAE stress probe;

The data control and acquisition system is used for:

determining an optimal excitation intensity corresponding to the pipe to be detected according to the material of the pipe to be detected, and determining an excitation frequency according to an expected magnetized penetration depth;

outputting a high-frequency alternating current by the OAE stress probe according to the optimal excitation intensity and the excitation frequency corresponding to the pipe to be detected, so as to generate an alternating magnetic field on the surface of the pipe to be detected and magnetize the surface of the pipe to be detected; and

detecting the axial pipe stress of the pipe to be detected by the OAE stress probe when the range of the alternating magnetic field generated on the surface of the pipe is smaller than a range of the stress generated by a deformation.

7) In a seventh aspect, the disclosure further provides a computer equipment including a processor, the processor is coupled with a memory, at least one computer program is stored in the memory, and the at least one computer program is loaded and run by the processor so as to enable the computer equipment to realize the method for detecting an axial pipe stress based on the OAE.

8) In an eighth aspect, the disclosure further provides a computer-readable storage medium. At least one computer program is stored in the computer-readable storage medium, and the computer-readable storage medium is loaded and run by a processor so as to enable the computer to realize the method for detecting an axial pipe stress based on the OAE.

It should be noted that the beneficial effects achieved by the technical solutions of the second aspect to the eighth aspect of the present disclosure and the corresponding possible ways of realizing them can be found in the technical effects above-mentioned for the first aspect and its corresponding possible ways of realizing it, and will not be repeated here.

### BRIEF DESCRIPTION OF THE DRAWINGS

Other characteristics, purposes and advantages of the disclosure will become apparent from a detailed description of non-limiting embodiments made with reference to the following drawings:

FIG. 1 is the first flowchart showing the method for detecting an axial pipe stress based on the OAE according to embodiments of the present disclosure;

FIG. 2 is a structural schematic diagram of the OAE stress probe according to embodiments of the present disclosure;

FIG. 3 is a circuit diagram of the excitation coil according to embodiments of the present disclosure;

FIG. 4 is a circuit diagram of the detection coil according to embodiments of the present disclosure;

FIG. 5 is a detection diagram of the stress probe according to embodiments of the present disclosure;

FIG. 6 is an arrangement diagram of the stress probe according to embodiments of the present disclosure;

FIG. 7 is a schematic diagram of the axial pipe stress detection according to embodiments of the present disclosure;

FIG. 8 is a comparison diagram of two stress detections according to embodiments of the present disclosure;

FIG. 9 is a structural schematic diagram of the device for detecting an axial pipe stress based on the OAE according to embodiments of the present disclosure;

FIG. 10 is a schematic structural diagram of the electronic equipment according to embodiments of the present disclosure.

FIG. 11 is the second flowchart showing the method for detecting an axial pipe stress based on the OAE according to embodiments of the present disclosure;

FIG. 12 is a structural schematic diagram of the system for detecting an axial pipe stress based on the OAE according to embodiments of the present disclosure;

FIG. 13 is a schematic structural diagram of the computer equipment according to embodiments of the present disclosure.

### DETAILED DESCRIPTION OF THE EMBODIMENTS

The principles and characteristics of the disclosure are described below. The examples given are only for explaining the disclosure, not for limiting the scope of the disclosure.

The technical solutions of the present disclosure and how to solve the above-mentioned technical problems are described in detail below with specific embodiments. The following detailed embodiments can be combined with each other, and the same or similar concepts or processes may not be described in some embodiments. Embodiments of the present disclosure will be described below with reference to the drawings.

The solution provided by the embodiments of the present disclosure can be applied to any application scenario in which the stress detection is required for a pipeline. The solutions provided by the embodiments of the present disclosure may be implemented by any electronic equipment, such as a user's terminal equipment, including at least one of the following: smart phone, tablet computer, notebook computer, desktop computer, smart speaker, smart watch, smart TV and smart vehicle-mounted equipment.

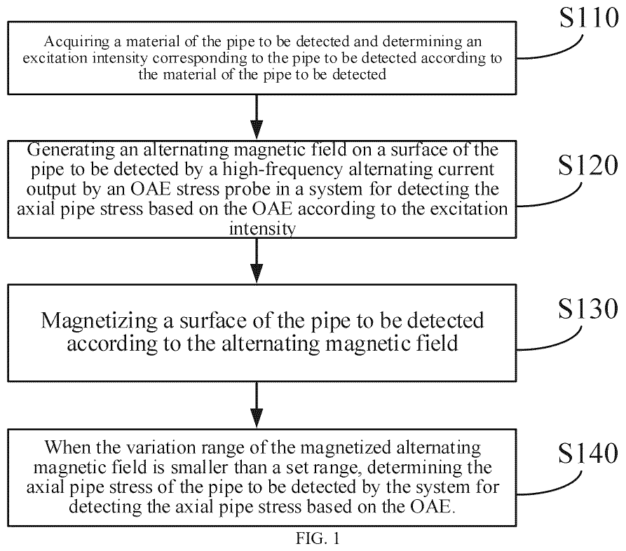

Embodiments of the present disclosure provide a possible implementation mode. As shown in FIG. 1, it provides a flowchart showing a method for detecting an axial pipe stress based on the OAE, and this solution can be executed by any electronic equipment, such as terminal equipment, or jointly executed by terminal equipment and server. For convenience of description, the method provided by the embodiments of the present disclosure will be described below by taking a terminal equipment as an execution subject for example. The method may include the following steps:

S110, acquiring a material of the pipe to be detected and determining an excitation intensity corresponding to the pipe to be detected according to the material of the pipe to be detected;

S120, generating an alternating magnetic field on a surface of the pipe to be detected by a high-frequency alternating current output by an OAE stress probe in a system for detecting the axial pipe stress based on the OAE according to the excitation intensity;

S130, magnetizing a surface of the pipe to be detected according to the alternating magnetic field; and

S140, when the variation range of the magnetized alternating magnetic field is smaller than a set range, determining the axial pipe stress of the pipe to be detected by the system for detecting the axial pipe stress based on the OAE.

In the solution of the present application, an alternating magnetic field is generated on a surface of the pipe to be detected by a high-frequency alternating current output by an OAE stress probe in a system for detecting the axial pipe stress based on the OAE. The alternating magnetic field magnetizes the surface of the pipe to be detected, which will change the magnetic field on the surface of the pipe to be detected, and then based on the change of the magnetic field, the axial pipe stress of the pipe to be detected can be detected. The solution of the present application has the advantages of high detection rate, fast speed, covering the whole pipeline, etc. By carrying an in-line detection robot, the stress-strain level of the whole oil and gas pipeline can be quickly detected, providing an effective means for finding and repairing stress-concentrated parts.

The solution of the present disclosure will be further described in combination with the following specific embodiments. Before describing the solution of this embodiment, in order to deepen the understanding of the solution of the present application, the principle of the present application and the system for detecting the axial pipe stress based on the OAE used will be introduced first. First, the principle of the solution of the present application is as follows:

Oil and gas pipes are generally made of carbon steel. When a certain magnetic field is applied to the outside of the pipe, the magnetization of ferromagnetic materials in the pipe will interact with the internal stress, which is called magnetostriction. When magnetostriction occurs, the physical effect that ferromagnetic materials undergo corresponding deformation with the change of applied magnetic field. When the applied magnetic field increases, the deformation becomes larger; when the applied magnetic field decreases, the deformation becomes smaller. When the material deformation is in the same direction as the applied magnetic field, it is longitudinal magnetostriction; when the material deformation is perpendicular to the applied magnetic field, it is transverse magnetostriction. The longitudinal and transverse deformations alone are called linear magnetostriction. If the volume of a material changes, it is called bulk magnetostriction. According to the inverse magnetoelastic (Villari) effect, due to the existence of additional stress, when the magnetized ferromagnetic body is deformed, its magnetization intensity also changes. If the change of magnetic field can be accurately induced, the axial pipe stress can be detected.

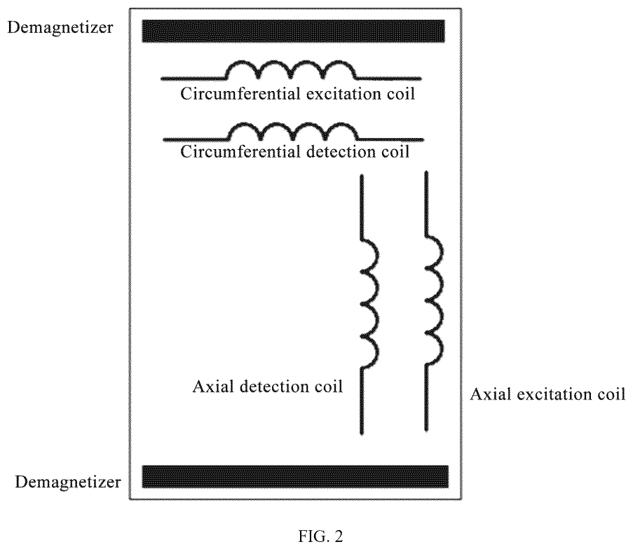

The system for detecting the axial pipe stress based on the OAE used in this solution mainly includes a power supply module, a data control and acquisition system and an OAE stress probe connected in sequence. The data control and acquisition system controls when the OAE stress probe collects stress. The components of the above-mentioned OAE stress probe can be seen in FIG. 2, including an axial excitation coil, a circumferential excitation coil, a circumferential detection coil and an axial detection coil. Where, two groups of axial coils are placed along the axial direction of the pipe, that is, the axial excitation coils are placed along the axial direction of the pipe to be detected, and the axial detection coils are placed along the axial direction of the pipe to be detected. In this way, an axial excitation intensity can be generated by the axial excitation coils, a circumferential excitation intensity can be generated by the axial excitation coils, and then the circumferential excitation intensity generates a circumferential alternating magnetic field, the axial excitation intensity generates an axial alternating magnetic field, that is, the alternating magnetic fields include an axial alternating magnetic field and a circumferential alternating magnetic field. Then, the pipe can be circumferentially magnetized based on the circumferential alternating magnetic field to finally obtain the circumferential pipe stress. The pipe can be magnetized axially based on the axial alternating magnetic field to finally obtain the axial pipe stress. The axial and circumferential stress detection of the pipe to be detected can be realized through the probe composed of the excitation coil and the detection coil.

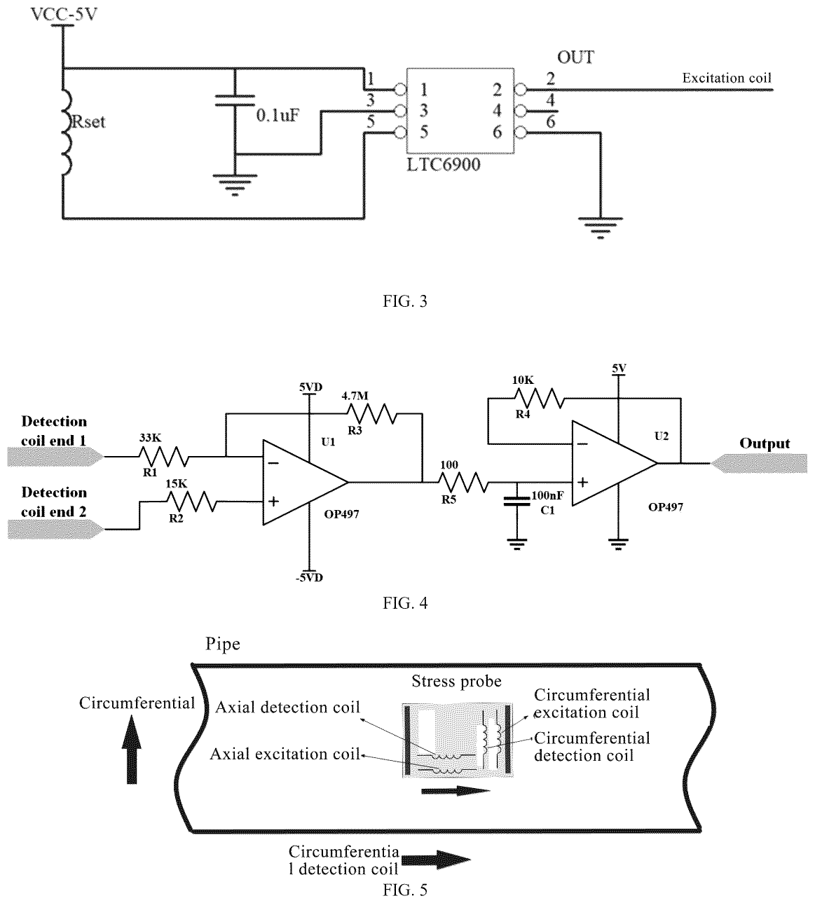

Alternatively, as shown in FIG. 3, the circuit corresponding to the above-mentioned excitation coil includes an oscillator (alternatively, it can be an LTC6900 oscillator), a first power supply (it can be a power supply providing 5V voltage) and a variable resistor Rset; a first end (pin 1) of the oscillator is connected with the first power supply, a third end (pin 3) and a sixth end (pin 6) of the oscillator are grounded, and a fifth end (pin 5) of the oscillator is connected with the variable resistor Rset. The variable resistor Rset is connected with the first power supply, and a second end (pin 2) of the oscillator outputs a corresponding high-frequency alternating current adjusted by the variable resistor Rset. After the variable resistor Rset is adjusted, different high-frequency alternating currents can be obtained correspondingly. Where, the high-frequency current is a current relative to an AC power frequency of 50 HZ. For example, the carrier current in the communication signals is a high-frequency current. In some occasions, in order to change the motor speed, it is necessary to use a frequency converter to convert the power frequency current into a relatively higher frequency current, and the above mentioned high-frequency alternating current specifically refers to an alternating current greater than 50 HZ. The principle of the circuit structure corresponding to the above-mentioned excitation coil is simple, which is convenient for quickly generating accurate high-frequency alternating currents.

Alternatively, as shown in FIG. 4, the circuit corresponding to the above-mentioned detection coil includes a second power supply (+5VD and −5VD), a third power supply (SV), a first resistor R1, a second resistor R2, a third resistor R3, a fourth resistor R4, a fifth resistor R5, a capacitor C1, a first amplifier U1 and a second amplifier U2;

a first end of the detection coil (the detection coil end 1 shown in FIG. 4) is connected with one end of the first resistor R1, the other end of the first resistor R1 is connected with a negative end (−) of the first amplifier U1, a second end of the detection coil (the detection coil end 2 shown in FIG. 4) is connected with one end of the second resistor R2, the other end of the second resistor R2 is connected with a positive end (+) of the first amplifier U1, and the negative end of the first amplifier U1 is connected with one end of the third resistor R3;

the other end of the third resistor R3 is connected with one end of the fifth resistor R5, the other end of the fifth resistor R3 is connected with a positive end of the second amplifier U2, a common end between the other end of the fifth resistor R3 and a positive end of the second amplifier U2 is connected with one end of the capacitor C1, the other end of the capacitor C1 is grounded, one end of the fourth resistor R4 is connected with a negative end of the second amplifier U2, and the other end of the fourth resistor R4 is connected with an output end (the output shown in FIG. 4) of the circuit corresponding to the detection coil.

The positive and negative power supplies of the first amplifier are respectively connected with +5 VD and −5 VD of the first power supply, the positive power supply of the second amplifier is connected with 5V of the second power supply, and the negative power supply is grounded.

Alternatively, the first amplifier U1 and the second amplifier U2 may be OP497 amplifiers.

The working principle of the above-mentioned detection coil circuit, i.e., the circuit corresponding to the detection coil is as follows:

U1 and the peripheral circuit constitute a front-end amplifier circuit, which amplifies the signal of the detection coil in the first stage. The first-stage amplified signal is input to the second amplifier U2 through a 100 ohm resistor R5 and a 47 nF capacitor C1. The 100 ohm resistor R5 and the 47 nF capacitor C1 constitute a low pass filter for filtering the high frequency noise of the first-stage amplified signal. The filtered detection signal is connected with the positive end of U2, and the negative end of U2 is connected with a 10 k resistor R4, which constitutes the second stage amplification of the detection coil. The second-stage amplified detection signal will be collected and stored by an electronic system after passing through an analog-to-digital converter to form the final detection signal, i.e. axial stress and circumferential stress of the pipe to be detected. Two groups of circumferential coils are orthogonally placed with the axial coils to detect the slight change in the magnetic field on the metal surface in the circumferential direction of the pipe, just like the axial coils. The circuit composition of the excitation coil and the detection coil is consistent with that of the axial coils. The principle of the circuit structure corresponding to the above-mentioned detection coil is simple, and the accurate axial stress and circumferential stress can be detected quickly.

The probe in the system for detecting the axial pipe stress based on the OAE is placed inside the pipe as shown in FIG. 5 and pushed forward along the axial direction of the pipe to detect the axial stress and circumferential stress at various positions in the pipe. The specific implementation process of the detection may includes the following steps:

S110, acquiring a material of the pipe to be detected and determining an excitation intensity corresponding to the pipe to be detected according to the material of the pipe to be detected;

S120, generating an alternating magnetic field on a surface of the pipe to be detected by a high-frequency alternating current output by an OAE stress probe in a system for detecting the axial pipe stress based on the OAE according to the excitation intensity;

S130, magnetizing a surface of the pipe to be detected according to the alternating magnetic field; and

S140, when the variation range of the magnetized alternating magnetic field is smaller than a set range, it indicates that the alternating magnetic field is relatively stable, determining the axial pipe stress (or axial stress) of the pipe to be detected by the system for detecting the axial pipe stress based on the OAE, with the circumferential stress of the pipe to be detected also being detected.

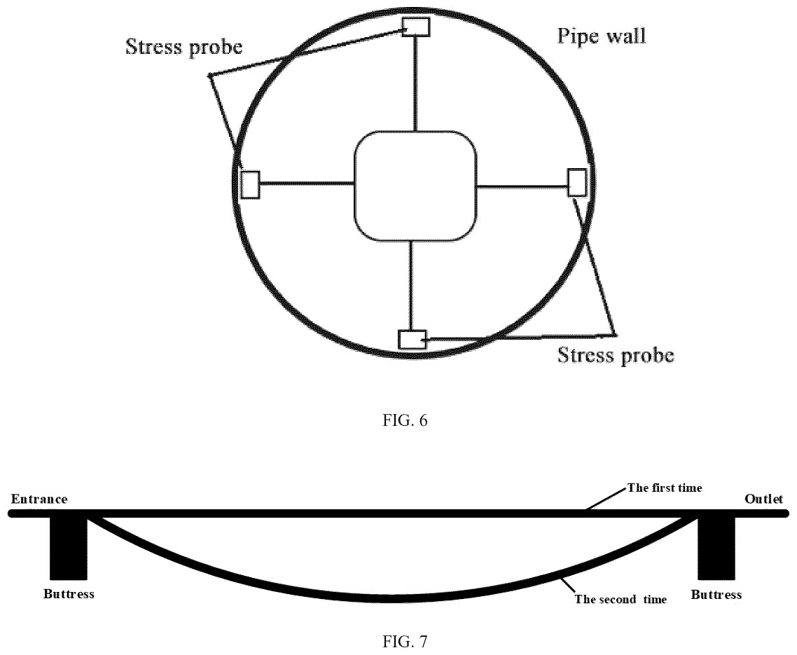

Due to the existence of surrounding geomagnetic environment or the fact that the pipe has been subjected to magnetic flux leakage detection, a part of residual magnetism will remain in the pipe body, which will also lead to inconsistent magnetic field environment generated during the axial stress detection. In order to unify the external magnetic field of the pipe during detecting by the stress probe, in the solution of the present application, a demagnetizer is respectively provided at a front end and a rear section of the OAE stress probe. The specific setting can be seen in FIG. 2. The probe advances at a certain speed along the axial direction of the pipe, which can scan the whole line of the area through which the probe passes, and collect the detection data through the back-end data acquisition system, which can simultaneously collect the data in two different directions: axial and circumferential. Since the area through which a single probe passes cannot cover the entire cross section of the pipe, multiple probes can be placed simultaneously in different directions of the cross section of the pipe to be detected to detect the whole pipe. Alternatively, four stress probes can be placed in the directions of 0 o'clock, 3 o'clock, 6 o'clock and 9 o'clock on the pipe section. If you want to detect the pipe stress more accurately, more stress probes need to be added, as shown in FIG. 6. These stress probes can be integrated on the in-line detection robot, and the probe is pressed against the inner wall of the pipe through a support arm. When the robot is running in the pipe, the stress probes placed in different directions will detect the pipe data at different azimuth points and detect the whole pipe.

Further, it includes determining a penetration depth corresponding to the pipe to be detected according to the high-frequency alternating current. The penetration depth represents the magnetized penetration depth, and a greater penetration depth indicates a deeper magnetized penetration depth, so the corresponding alternating electromagnetic detection depth is also larger. If the penetration depth is smaller, the detection depth is smaller. Since the penetration depth generated by the alternating electromagnetism will be related to the excitation frequency, in order to make the stress measurement more accurate, it is necessary to select an appropriate excitation frequency, then, according to the determination of penetration depth, the excitation frequency corresponding to the material of the pipe to be detected can be determined more accurately. Specifically:

In the detection of alternating electromagnetism, the penetration depth of local magnetization is generally expressed by δ. The larger δ, the deeper the magnetized penetration depth, and the greater the corresponding detection depth of the alternating electromagnetism. If the penetration depth δ is small, the detection depth is small. According to the penetration depth equation, the penetration depth caused by alternating electromagnetism will be related to the excitation frequency. In order to make the stress measurement more accurate, it is necessary to select an appropriate excitation frequency to ensure that the detected penetration depth can better detect the magnetization intensity caused by pipe deformation. According to different pipe material properties, different excitation intensities (which can be determined by the excitation frequency f) are chosen, generally 3˜6 kHz. The penetration depth equation is as follows:

$$δ = \frac{1}{\sqrt{π f μ σ}}$$

Where, δ represents the penetration depth in mm; σ represents the resistivity in 10 Ψ·mm/m; f represents the excitation frequency in Hz; μ represents the relative permeability of materials. Pipes made of different materials correspond to different excitation frequencies, which can be determined based on the above-mentioned penetration depth equation, that is, the corresponding excitation frequency can be determined according to the relative permeability of the material of the pipe to be detected.

In order to better illustrate and understand the principle of the method provided by the present disclosure, an alternative detailed embodiment below is taken to explain the solution of the present disclosure. It should be noted that the specific implementation manner of each step in this detailed embodiment shall not be understood as a limitation to the solution provided by the present disclosure, and other implementation manners that those skilled in the art can think of based on the principle of the solution provided by the present disclosure shall also be deemed to fall within the protection scope of the present disclosure.

A deformation detector is used to carry four axial stress probes placed in different directions. The diameter of the detected pipe is 28 inches (508 mm). The running speed of the detector is set within the range of 1˜3 m/s, and the length of the pipe is about 90 m. As shown in FIG. 7, a baseline detection is first carried out when the pipe is placed horizontally to obtain the stress data of the whole pipe, and then sinking is carried out for the pipe at the middle position of the pipe. Additional stress will be generated after bending of the pipe, and the detector is operated again to detect the pipe stress.

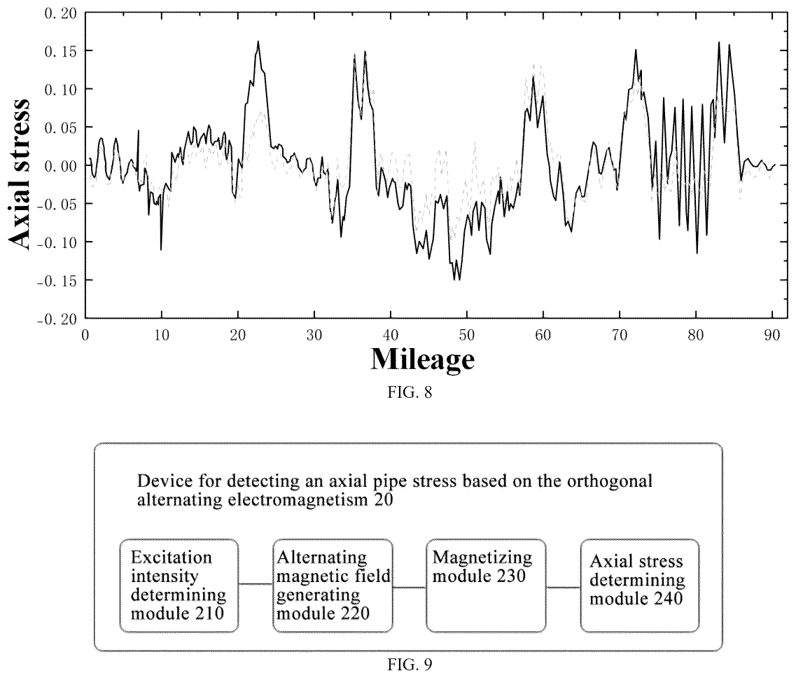

As shown in FIG. 8, the dotted line is the overall stress level when the pipe is placed horizontally, and the solid line is the overall stress level of the pipe after the pipe sinks. As is apparent from FIG. 8, the method of the present disclosure can detect changes in stress when additional stresses are generated due to deflection of the pipe body. In the middle of the pipe, the initial strain value is about −0.105% when the pipe is placed horizontally, and the strain value of the pipe at the same position is about −0.152% after the pipe sinks. Since the pipe is in an elastic range, the actual stress of the pipe shall be strain (axial stress or circumferential stress detected) x elastic modulus. Where, the elastic modulus is about 2×1011 Pa, so the initial stress when the pipe is horizontally placed is about 200 MPa and the stress after pipe sinking is about 300 MPa.

Through tests in this embodiment, the method and system for detecting the axial pipe stress proposed by the disclosure have the advantages of high detection rate, fast speed, covering the whole pipeline, etc. By carrying an in-line detection robot, the stress-strain level of the whole oil and gas pipeline can be quickly detected, providing an effective means for finding and repairing stress-concentrated parts.

Based on the same principle as that of the method shown in FIG. 1, a device for detecting the axial pipe stress based on the OAE 20 is further provided in this embodiment of the present disclosure, and as shown in FIG. 9, the device for detecting the axial pipe stress based on the OAE 20 may include an excitation intensity determining module 210, an alternating magnetic field generating module 220, a magnetizing module 230 and an axial stress determining module 240, wherein:

the excitation intensity determination module 210 is for acquiring a material of the pipe to be detected and determining an excitation intensity corresponding to the pipe to be detected according to the material of the pipe to be detected;

the alternating magnetic field generating module 220 is for generating an alternating magnetic field on a surface of the pipe to be detected by a high-frequency alternating current output by an OAE stress probe in a system for detecting the axial pipe stress based on the OAE according to the excitation intensity;

the magnetizing module 230 is for magnetizing a surface of the pipe to be detected according to the alternating magnetic field; and the axial stress determining module 240 is, when the variation range of the magnetized alternating magnetic field is smaller than the set range, for determining the axial pipe stress of the pipe to be detected by the system for detecting the axial pipe stress based on the OAE.

Alternatively, the OAE stress probe includes an excitation coil and a detection coil; the excitation coil includes an axial excitation coil and a circumferential excitation coil, and the axial excitation coil is placed in accordance with an axial direction of the pipe to be detected; the detection coil includes an axial detection coil and a circumferential detection coil, the axial detection coil is placed in accordance with an axial direction of the pipe to be detected; and the alternating magnetic field includes an axial alternating magnetic field and a circumferential alternating magnetic field.

Alternatively, a circuit corresponding to the above-mentioned excitation coil includes an oscillator, a first power supply and a variable resistor; a first end of the oscillator is connected with the first power supply, a third end and a sixth end of the oscillator are grounded, a fifth end of the oscillator is connected with the variable resistor, the variable resistor is connected with the first power supply, and a second end of the oscillator outputs a corresponding high-frequency alternating current adjusted by the variable resistor.

Alternatively, the circuit corresponding to the above-mentioned detection coil includes a second power supply, a third power supply, a first resistor, a second resistor, a third resistor, a fourth resistor, a fifth resistor, a capacitor, a first amplifier and a second amplifier;

a first end of the detection coil is connected with one end of the first resistor, the other end of the first resistor is connected with a negative end of the first amplifier, a second end of the detection coil is connected with one end of the second resistor, the other end of the second resistor is connected with a positive end of the first amplifier, and the negative end of the first amplifier is connected with one end of the third resistor;

the other end of the third resistor is connected with one end of the fifth resistor, the other end of the fifth resistor is connected with a positive end of the second amplifier, a common end between the other end of the fifth resistor and a positive end of the second amplifier is connected with one end of the capacitor, the other end of the capacitor is grounded, one end of the fourth resistor is connected with a negative end of the second amplifier, and the other end of the fourth resistor is connected with an output end of the circuit corresponding to the detection coil.

Alternatively, the above-mentioned device further includes:

a penetration depth determining module, for determining the penetration depth corresponding to the pipe to be detected according to the high-frequency alternating current.

Alternatively, the above-mentioned system for detecting an axial pipe stress based on the OAE further includes two demagnetizers, which are respectively placed at a front end and a rear section of the OAE stress probe. A part of residual magnetism will remain in the pipe body, which will also lead to an inconsistent magnetic field environment generated during the axial stress detection. By providing two demagnetizers, the external magnetic field of the pipe during the stress probe detection can be identified.

Alternatively, the above-mentioned OAE stress probe includes a plurality of stress probes, each stress probe is provided in different directions of the pipe section of a pipe to be detected, and the device further includes:

a pipe stress acquiring module, for acquiring an axial pipe stress and a circumferential pipe stress in the area corresponding to each of the stress probes through each of the stress probes. Since the area through which a single probe passes cannot cover the entire cross section of the pipe, it is necessary to place multiple probes on the cross section of the pipe at the same time to detect the whole pipeline and realize the stress detection of the whole pipeline to be detected.

The device for detecting the axial pipe stress based on the OAE according to the embodiments of the present disclosure can execute the method for detecting the axial pipe stress based on the OAE provided in the embodiments of the present disclosure, and their implementation principles are similar. Actions executed by each module and unit in the device for detecting the axial pipe stress based on the OAE in each embodiment of the present disclosure correspond to steps in the method for detecting the axial pipe stress based on the OAE in each embodiment of the present disclosure. For the detailed functional description of each module of the device for detecting the axial pipe stress based on the OAE, please refer to the description in the corresponding method for detecting the axial pipe stress based on the OAE shown above, which will not be repeated here.

Where, the device for detecting the axial pipe stress based on the OAE may be a computer program (including program codes) running in the computer equipment. For example, the device for detecting the axial pipe stress based on the OAE is an application software and can be used to execute corresponding steps in the method provided by the embodiments of the present disclosure.

In some embodiments, the device for detecting the axial pipe stress based on the OAE provided by the embodiments of the present disclosure can be implemented by combining software with hardware. As an example, the device for detecting the axial pipe stress based on the OAE provided by the embodiments of the present disclosure may be a processor in the form of a hardware decoded processor, which is programmed to execute the method for detecting the axial pipe stress based on the OAE provided by the embodiments of the present disclosure. For example, a processor in the form of a hardware decoded processor may employ one or more Application Specific Integrated Circuit (ASIC), DSP, Programmable Logic Device (PLD), Complex Programmable Logic Device (CPLD), Field-Programmable Gate Array (FPGA) or other electronic elements.

In other embodiments, the device for detecting the axial pipe stress based on the OAE provided in the embodiments of the present disclosure can be implemented by software. FIG. 9 shows the device for detecting the axial pipe stress based on the OAE stored in memory, which may be software in the form of programs and plug-ins, and includes a series of modules, including an excitation intensity determining module 210, an alternating magnetic field generating module 220, a magnetizing module 230 and an axial stress determining module 240. It is used to implement the method for detecting the axial pipe stress based on the OAE provided in the embodiments of the present disclosure.

The modules described in the embodiments of the present disclosure may be implemented by software or hardware. Where, the name of a module does not constitute limitation to the module itself in some cases.

Based on the same principle as the method shown in the embodiments of the present disclosure, an electronic equipment is further provided in the embodiments of the present disclosure. The electronic equipment may include but not be limited to: a processor and a memory. The memory is for storing computer programs and the processor is for executing the method shown in any embodiment of the present disclosure by calling the computer program.

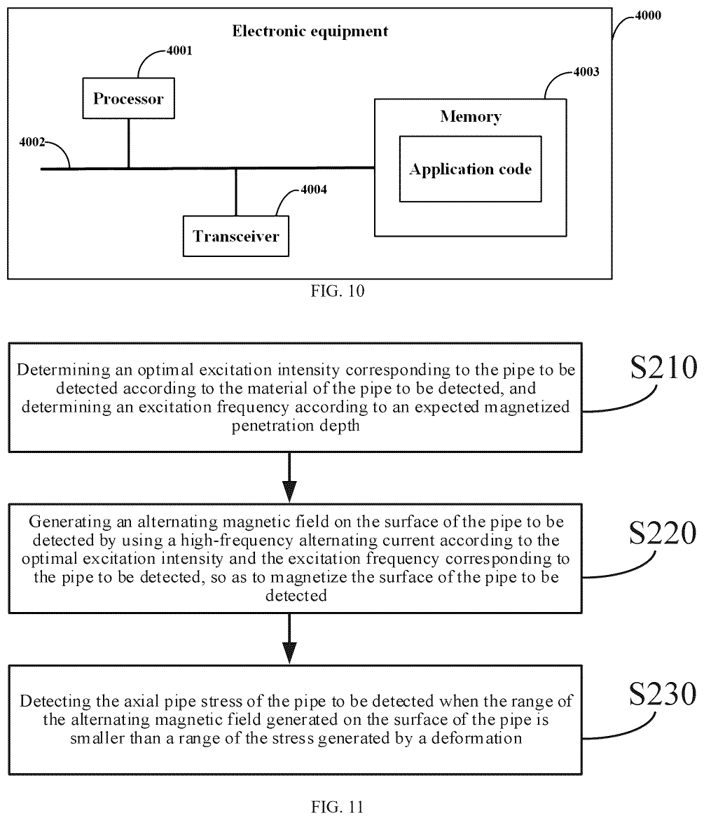

In an alternative embodiment, an electronic equipment is provided. As shown in FIG. 10, the electronic equipment 4000 includes a processor 4001 and a memory 4003. Where, the processor 4001 is connected with the memory 4003, such as through a bus 4002. Alternatively, the electronic equipment 4000 may further include a transceiver 4004 for data interaction between the electronic equipment and other electronic equipment, such as transmission and/or reception of data. It should be noted that the actual application is not limited to one transceiver 4004, and the structure of the electronic equipment 4000 does not limit the embodiments of the present disclosure.

The processor 4001 may be a Central Processing Unit (CPU), a general-purpose processor, a Digital Signal Processor (DSP), an Application Specific Integrated Circuit (ASIC), a Field Programmable Gate Array (FPGA) or other programmable logic devices, transistor logic devices, hardware component or any combination thereof. Various exemplary logic blocks, modules and circuits described in connection with the present disclosure may be implemented or executed thereby. The processor 4001 may also be a combination that implements computing functions, such as including one or more microprocessor combinations, DSP and microprocessor combinations, etc.

The bus 4002 may include a pathway for transferring information between the above-mentioned components. The bus 4002 may be a Peripheral Component Interconnect (PCI) bus or an Extended Industry Standard Architecture (EISA) bus, or the like. The bus 4002 may be address bus, data bus, control bus, etc. For convenience of illustration, the bus is represented only by a thick line in FIG. 10, but it does not mean that there is only one bus or one type of bus.

The memory 4003 may be a Read Only Memory (ROM) or other type of static storage equipment capable of storing static information and instructions, a Random Access Memory (RAM) or other type of dynamic storage equipment capable of storing information and instructions, or an Electrically Erasable Programmable Read Only Memory (EEPROM), Compact Disc Read Only Memory (CD-ROM) or other optical disc memory (including compact disc, laser disc, optical disc, digital versatile disc, blue-ray disc, etc.), magnetic disc storage medium or other magnetic storage equipment, or any other medium capable of carrying or storing the desired program code in the form of instructions or data structures and accessible by a computer, but not limited to this.

The memory 4003 is configured to store the application code (computer program) for executing the solution of the present disclosure, and the execution thereof is controlled by the processor 4001. The processor 4001 is configured to execute the application code stored in the memory 4003 to implement what is shown in the foregoing method embodiment.

The electronic equipment may also be a terminal equipment, and the electronic equipment shown in FIG. 10 is only an example, which should not bring any limitation to the functions and application scope of the embodiments of the present disclosure.

Embodiments of the present disclosure provide a computer-readable storage medium, in which a computer program is stored, so that when it runs on a computer, the computer can execute what is shown in the foregoing method embodiment.

According to another aspect of the disclosure, there is further provided a computer program product or computer program. The computer program product or computer program includes computer instructions stored in a computer-readable storage medium. The processor of the computer device reads the computer instructions from a computer-readable storage medium, and the processor executes the computer instructions so that the computer device performs the orthogonal alternating electromagnetic based pipeline axial stress detection method provided in various embodiment implementations above-mentioned.

As shown in FIG. 11, the method for detecting an axial pipe stress based on the OAE according to embodiments of the present disclosure includes the following steps:

S210, determining an optimal excitation intensity corresponding to the pipe to be detected according to the material of the pipe to be detected, and determining an excitation frequency according to an expected magnetized penetration depth;

where, under different excitation intensities of the same material of the pipe to be detected, if the excitation intensity is low, the alternating magnetic field generated on the surface of the pipe will be weak and difficult to be detected. If the excitation intensity is high, although it is easy to be detected, the circuit used to generate high-frequency alternating current needs to be improved with high cost and waste of electric energy resources. Through preliminary experiments, on the premise of ensuring easy detection, no need to improve the circuit generating high-frequency alternating current, and no waste of electric energy resources, determine the optimal excitation intensity of different materials of pipes to be detected at different excitation intensities.

It should be noted that on the premise of ensuring easy detection, no need to improve the circuit generating high-frequency alternating current and no waste of electric energy resources, the excitation intensity corresponding to the material of the same pipe to be detected is within a range. Researchers can determine the optimal excitation intensity from this range according to experience, or randomly select an excitation intensity from this range as the optimal excitation intensity.

In S110, the excitation intensity corresponding to the pipe to be detected is determined according to the material of the pipe to be detected, which can be understood as determining an optimal excitation intensity corresponding to the pipe to be detected.

Where, the desired magnetized penetration depth may be set according to actual conditions, and the relationship between the magnetized penetration depth and the excitation frequency is as described above, whereby the excitation frequency can be determined according to the desired magnetized penetration depth.

S220, generating an alternating magnetic field on the surface of the pipe to be detected by using a high-frequency alternating current according to the optimal excitation intensity and the excitation frequency corresponding to the pipe to be detected, so as to magnetize the surface of the pipe to be detected;

S230, detecting the axial pipe stress of the pipe to be detected when the range of the alternating magnetic field generated on the surface of the pipe is smaller than a range of the stress generated by a deformation.

The specific implementation process of S210 to S230 is detailed in the above embodiments and will not be described again.

A system for detecting an axial pipe stress based on the orthogonal alternating electromagnetism (OAE) according to embodiments of the present disclosure includes a data control and acquisition system and an OAE stress probe;

The data control and acquisition system is used for:

determining an optimal excitation intensity corresponding to the pipe to be detected according to the material of the pipe to be detected, and determining an excitation frequency according to an expected magnetized penetration depth;

outputting a high-frequency alternating current by the OAE stress probe according to the optimal excitation intensity and the excitation frequency corresponding to the pipe to be detected, so as to generate an alternating magnetic field on the surface of the pipe to be detected and magnetize the surface of the pipe to be detected; and

detecting the axial pipe stress of the pipe to be detected by the OAE stress probe when the range of the alternating magnetic field generated on the surface of the pipe is smaller than a range of the stress generated by a deformation.

Alternatively, in the above-mentioned technical solution, the OAE stress probe includes an excitation coil and a detection coil; the excitation coil includes an axial excitation coil and a circumferential excitation coil, and the axial excitation coil is placed in accordance with an axial direction of the pipe to be detected; the detection coil includes an axial detection coil and a circumferential detection coil, the axial detection coil is placed in accordance with an axial direction of the pipe to be detected; and

the alternating magnetic field includes an axial alternating magnetic field and a circumferential alternating magnetic field.

Where, the data control and acquisition system may be specifically a chip, processor or server, etc., or the data control and acquisition system is provided with operation software convenient for users to realize corresponding functions.

Alternatively, in the above-mentioned technical solution, a circuit corresponding to the above-mentioned excitation coil includes an oscillator, a first power supply and a variable resistor; a first end of the oscillator is connected with the first power supply, a third end and a sixth end of the oscillator are grounded, a fifth end of the oscillator is connected with the variable resistor, the variable resistor is connected with the first power supply, and a second end of the oscillator outputs a corresponding high-frequency alternating current adjusted by the variable resistor.

Alternatively, in the above-mentioned technical solution, the circuit corresponding to the above-mentioned detection coil includes a second power supply, a third power supply, a first resistor, a second resistor, a third resistor, a fourth resistor, a fifth resistor, a capacitor, a first amplifier and a second amplifier;

a first end of the detection coil is connected with one end of the first resistor, the other end of the first resistor is connected with a negative end of the first amplifier, a second end of the detection coil is connected with one end of the second resistor, the other end of the second resistor is connected with a positive end of the first amplifier, and the negative end of the first amplifier is connected with one end of the third resistor;

the other end of the third resistor is connected with one end of the fifth resistor, the other end of the fifth resistor is connected with a positive end of the second amplifier, a common end between the other end of the fifth resistor and a positive end of the second amplifier is connected with one end of the capacitor, the other end of the capacitor is grounded, one end of the fourth resistor is connected with a negative end of the second amplifier, and the other end of the fourth resistor is connected with an output end of the circuit corresponding to the detection coil.

Alternatively, in the above-mentioned technical solution, it further includes two demagnetizers, which are respectively placed at a front end and a rear section of the OAE stress probe.

Alternatively, in the above-mentioned technical solution, the OAE stress probe further includes a plurality of stress probes, each stress probe is provided in different directions of the pipe section of a pipe to be detected, and the data control and acquisition system is specifically used for:

acquiring an axial pipe stress and a circumferential pipe stress in the area corresponding to each of the stress probes through each of the stress probes.

The specific implementation process of the above-mentioned system for detecting the axial pipe stress based on the OAE is detailed in the above embodiments, which will not be repeated here.

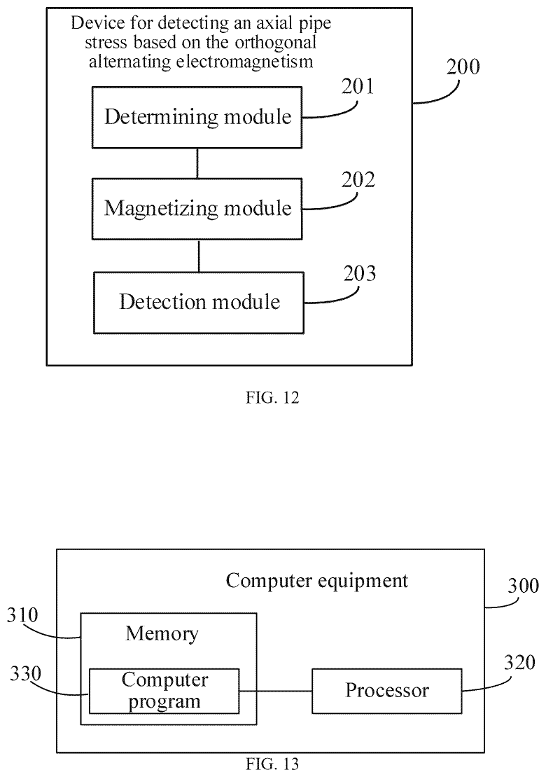

As shown in FIG. 12, a device for detecting the axial pipe stress based on the OAE 200 according to embodiments of the present disclosure includes a determining module 201, a magnetizing module 202 and a detection module 203;

the determining module 201 is used for determining an optimal excitation intensity corresponding to the pipe to be detected according to the material of the pipe to be detected, and determining an excitation frequency according to an expected magnetized penetration depth;

the magnetizing module 202 is used for generating an alternating magnetic field on the surface of the pipe to be detected by using a high-frequency alternating current according to the optimal excitation intensity and the excitation frequency corresponding to the pipe to be detected, so as to magnetize the surface of the pipe to be detected; and

the detection module 203 is used for detecting the axial pipe stress of the pipe to be detected when the range of the alternating magnetic field generated on the surface of the pipe is smaller than a range of the stress generated by a deformation.

Where, in the device for detecting the axial pipe stress based on the OAE according to this embodiment, the corresponding executors of the determining module, the magnetizing module and the detection module may be a data control acquisition system.

As shown in FIG. 13, the embodiments of the present disclosure provide a computer equipment 300. The computer equipment 300 includes a processor 320, the processor 320 is coupled with a memory 310, at least one computer program 330 is stored in the memory 310, and the at least one computer program 330 is loaded and run by the processor 320 so as to enable the computer equipment 300 to realize the method for detecting an axial pipe stress based on the OAE. Specifically:

the computer equipment 300 may vary greatly due to different configurations or performances, and may include one or more processors 320 (Central Processing Units, CPU) and one or more memories 310, wherein at least one computer program 330 is stored in the one or more memories 310 and loaded and run by the one or more processors 320. In this way, the computer equipment 300 can realize the method for detecting an axial pipe stress based on the OAE provided in the above-mentioned embodiments. Certainly, the computer equipment 300 may further include components such as a wired or wireless network interface, a keyboard and an input/output interface for performing input and output. The computer equipment 300 may further include other components for implementing functions of the equipment, which will not be described here again.

A computer-readable storage medium according to an embodiment of the present disclosure, wherein at least one computer program is stored in the computer-readable storage medium, and the computer-readable storage medium is loaded and run by a processor so as to enable the computer to realize the method for detecting an axial pipe stress based on the OAE.

Alternatively, the computer-readable storage medium may be Read-Only Memory (ROM), Random Access Memory (RAM), Compact Disc Read-Only Memory (CD-ROM), magnetic tape, floppy disk and optical data storage equipment, etc.

Computer program codes for performing the operations of the present disclosure may be written in one or more programming languages, including object-oriented programming languages such as Java, Smalltalk, C++ and also conventional procedural programming languages such as “C”. The program code may be executed entirely on a user's computer, partially on the user's computer, as a stand-alone software package, partially on the user's computer and partially on a remote computer, or entirely on a remote computer or server. In cases involving remote computers, the remote computer may be connected with a user computer through any kind of network including a local area network (LAN) or a wide area network (WAN), or may be connected with an external computer (e.g., via the Internet using an Internet service provider).

It should be understood that the flowcharts and block diagrams in the drawings illustrate the architecture, functionality, and operation of possible implementations of methods and computer program products according to various embodiments of the present disclosure. In this regard, each block in a flowchart or block diagram may represent a module, segment, or portion of code that contains one or more executable instructions for implementing the specified logical functions. It should also be noted that in some alternative implementations, the functions labeled in the blocks may occur in a different order than those labeled in the drawings. For example, two successively represented blocks may actually be executed substantially in parallel or they may sometimes be executed in reverse order depending on the function involved. It is also noted that each block in the block diagram and/or flowchart, as well as combinations of blocks in the block diagram and/or flowchart, may be implemented with special purpose hardware-based systems performing specified functions or operations, or may be implemented with a combination of special purpose hardware and computer instructions.

The computer-readable storage medium carries one or more programs that, when executed by the electronic equipment, cause the electronic equipment to execute the method shown in the above-mentioned embodiments.

The above description is only a description of the preferred embodiments of the present disclosure and the technical principles used. Those skilled in the art should understand that the scope of disclosure involved in the present disclosure is not limited to the technical solutions formed by specific combinations of the above technical features, and shall also cover other technical solutions formed by any combination of the above technical features or their equivalent features without departing from the disclosed concept. For example, the technical solution formed by replacing the above features with (but not limited to) the technical features with similar functions disclosed in the disclosure.

What is claimed is:

1. A method for detecting an axial pipe stress based on the-an orthogonal alternating electromagnetism (OAE), comprising the following steps:
acquiring a material of a pipe to be detected and determining an excitation intensity corresponding to the pipe to be detected according to the material of the pipe to be detected;
generating an alternating magnetic field on a surface of the pipe to be detected by a high-frequency alternating current output by an OAE stress probe in a system for detecting the axial pipe stress based on the OAE according to the excitation intensity;
magnetizing a the surface of the pipe to be detected according to the alternating magnetic field to obtain a magnetized alternating magnetic field; and
when a variation range of the magnetized alternating magnetic field is smaller than a set range, determining the axial pipe stress of the pipe to be detected by the system for detecting the axial pipe stress based on the OAE.

2. The method for detecting the axial pipe stress based on the OAE according to claim 1, wherein the OAE stress probe comprises an excitation coil and a detection coil; the excitation coil comprises an axial excitation coil and a circumferential excitation coil, and the axial excitation coil is placed in accordance with an axial direction of the pipe to be detected; the detection coil comprises an axial detection coil and a circumferential detection coil, and the axial detection coil is placed in accordance with the axial direction of the pipe to be detected; and
the alternating magnetic field comprises an axial alternating magnetic field and a circumferential alternating magnetic field.

3. The method for detecting the axial pipe stress based on the OAE according to claim 2, wherein a circuit corresponding to the excitation coil comprises an oscillator, a first power supply and a variable resistor; a first end of the oscillator is connected with the first power supply, a third end and a sixth end of the oscillator are grounded, a fifth end of the oscillator is connected with the variable resistor, the variable resistor is connected with the first power supply, and a second end of the oscillator outputs a corresponding high-frequency alternating current adjusted by the variable resistor.

4. The method for detecting the axial pipe stress based on the OAE according to claim 2, wherein a circuit corresponding to the detection coil comprises a second power supply, a third power supply, a first resistor, a second resistor, a third resistor, a fourth resistor, a fifth resistor, a capacitor, a first amplifier and a second amplifier;
a first end of the detection coil is connected with a first end of the first resistor, other a second end of the first resistor is connected with a negative end of the first amplifier, a second end of the detection coil is connected with a first end of the second resistor, a second end of the second resistor is connected with a positive end of the first amplifier, and the negative end of the first amplifier is connected with a first end of the third resistor; and
a second end of the third resistor is connected with a first_end of the fifth resistor, a second end of the fifth resistor is connected with a positive end of the second amplifier, a common end between the second end of the fifth resistor and the positive end of the second amplifier is connected with a first end of the capacitor, a second end of the capacitor is grounded, a first end of the fourth resistor is connected with a negative end of the second amplifier, and a second end of the fourth resistor is connected with an output end of the circuit corresponding to the detection coil

5. The method for detecting the axial pipe stress based on the OAE according to claim 1, further comprising:
determining a penetration depth corresponding to the pipe to be detected according to the high-frequency alternating current.

6. The method for detecting the axial pipe stress based on the OAE according to claim 1, wherein the system for detecting the axial pipe stress based on the OAE comprises two demagnetizers, wherein the two demagnetizers are respectively placed at a front end and a rear section of the OAE stress probe.

7. The method for detecting the axial pipe stress based on the OAE according to claim 1, wherein the OAE stress probe comprises a plurality of stress probes, each of the plurality of stress probes is provided in different directions of a pipe section of the pipe to be detected, and the method further comprises:
acquiring an axial pipe stress and a circumferential pipe stress in an area corresponding to each of the plurality of stress probes through each of the plurality of stress probes.

8. A device for detecting an axial pipe stress based on an orthogonal alternating electromagnetism (OAE), comprising:
an excitation intensity determination module, for acquiring a material of a pipe to be detected and determining an excitation intensity corresponding to the pipe to be detected according to the material of the pipe to be detected;
an alternating magnetic field generating module, for generating an alternating magnetic field on a surface of the pipe to be detected by a high-frequency alternating current output by an OAE stress probe in a system for detecting the axial pipe stress based on the OAE according to the excitation intensity;
a magnetizing module, for magnetizing the surface of the pipe to be detected according to the alternating magnetic field to obtain a magnetized alternating magnetic field; and
an axial stress determining module, when a variation range of the magnetized alternating magnetic field is smaller than a set range, for determining the axial pipe stress of the pipe to be detected by the system for detecting the axial pipe stress based on the OAE.

9. An electronic equipment, comprising a memory, a processor and a computer program stored in the memory and configured to run on the processor; wherein when the processor runs the computer program, the method for detecting the axial pipe stress based on the OAE according to claim 1 is realized.

10. A computer-readable storage medium, wherein a computer program is stored on the computer-readable storage medium, and when the computer program is run by a processor, the method for detecting the axial pipe stress based on the OAE according to claim 1 is realized.

11. A method for detecting an axial pipe stress based on an orthogonal alternating electromagnetism (OAE), comprising:
determining an optimal excitation intensity corresponding to a pipe to be detected according to a material of the pipe to be detected, and determining an excitation frequency according to an expected magnetized penetration depth;
generating an alternating magnetic field on a surface of the pipe to be detected by using a high-frequency alternating current according to the optimal excitation intensity and the excitation frequency corresponding to the pipe to be detected, so as to magnetize the surface of the pipe to be detected; and
detecting the axial pipe stress of the pipe to be detected when a range of the alternating magnetic field generated on the surface of the pipe is smaller than a range of a stress generated by a deformation.

12. A system for detecting an axial pipe stress based on an orthogonal alternating electromagnetism (OAE), comprising a data control and acquisition system and an OAE stress probe; wherein
the data control and acquisition system is used for:
determining an optimal excitation intensity corresponding to a pipe to be detected according to a material of the pipe to be detected, and determining an excitation frequency according to an expected magnetized penetration depth;
outputting a high-frequency alternating current by the OAE stress probe according to the optimal excitation intensity and the excitation frequency corresponding to the pipe to be detected, so as to generate an alternating magnetic field on a surface of the pipe to be detected and magnetize the surface of the pipe to be detected; and
detecting the axial pipe stress of the pipe to be detected by the OAE stress probe when a range of the alternating magnetic field generated on the surface of the pipe is smaller than a range of a stress generated by a deformation.

13. The system for detecting the axial pipe stress based on the OAE according to claim 12, wherein the OAE stress probe comprises an excitation coil and a detection coil; the excitation coil comprises an axial excitation coil and a circumferential excitation coil, and the axial excitation coil is placed in accordance with an axial direction of the pipe to be detected; the detection coil comprises an axial detection coil and a circumferential detection coil, and the axial detection coil is placed in accordance with the axial direction of the pipe to be detected; and
the alternating magnetic field comprises an axial alternating magnetic field and a circumferential alternating magnetic field.

14. The system for detecting the axial pipe stress based on the OAE according to claim 13, wherein a circuit corresponding to the excitation coil comprises an oscillator, a first power supply and a variable resistor; a first end of the oscillator is connected with the first power supply, a third end and a sixth end of the oscillator are grounded, a fifth end of the oscillator is connected with the variable resistor, the variable resistor is connected with the first power supply, and a second end of the oscillator outputs a corresponding high-frequency alternating current adjusted by the variable resistor.

15. The system for detecting the axial pipe stress based on the OAE according to claim 13, wherein a circuit corresponding to the detection coil comprises a second power supply, a third power supply, a first resistor, a second resistor, a third resistor, a fourth resistor, a fifth resistor, a capacitor, a first amplifier and a second amplifier;
a first end of the detection coil is connected with a first_end of the first resistor, a second end of the first resistor is connected with a negative end of the first amplifier, a second end of the detection coil is connected with a first end of the second resistor, a second end of the second resistor is connected with a positive end of the first amplifier, and the negative end of the first amplifier is connected with a first end of the third resistor; and
a second end of the third resistor is connected with a first end of the fifth resistor, a second end of the fifth resistor is connected with a positive end of the second amplifier, a common end between the second end of the fifth resistor and the positive end of the second amplifier is connected with a first end of the capacitor, a second end of the capacitor is grounded, a first end of the fourth resistor is connected with a negative end of the second amplifier, and a second end of the fourth resistor is connected with an output end of the circuit corresponding to the detection coil

16. The system for detecting the axial pipe stress based on the OAE according to claim 12, further comprising two demagnetizers, wherein the two demagnetizers are respectively placed at a front end and a rear section of the OAE stress probe.

17. The system for detecting the axial pipe stress based on the OAE according to claim 12, wherein the OAE stress probe further comprises a plurality of stress probes, each of the plurality of stress probes is provided in different directions of a pipe section of the pipe to be detected, and the data control and acquisition system is used for:
acquiring an axial pipe stress and a circumferential pipe stress in an area corresponding to each of the plurality of stress probes through each of the plurality of stress probes.

18. A device for detecting an axial pipe stress based on an orthogonal alternating electromagnetism (OAE), comprising a determining module, a magnetizing module and a detection module; wherein
the determining module is used for determining an optimal excitation intensity corresponding to a pipe to be detected according to a material of the pipe to be detected, and determining an excitation frequency according to an expected magnetized penetration depth;
the magnetizing module is used for generating an alternating magnetic field on a surface of the pipe to be detected by using a high-frequency alternating current according to the optimal excitation intensity and the excitation frequency corresponding to the pipe to be detected, so as to magnetize the surface of the pipe to be detected; and
the detection module is used for detecting the axial pipe stress of the pipe to be detected when a range of the alternating magnetic field generated on the surface of the pipe is smaller than a range of a stress generated by a deformation.

19. A computer equipment, comprising a processor, wherein the processor is coupled with a memory, at least one computer program is stored in the memory, and the at least one computer program is loaded and run by the processor so as to enable the computer equipment to realize the method for detecting the axial pipe stress based on the OAE according to claim 11.

20. A computer-readable storage medium, wherein at least one computer program is stored in the computer-readable storage medium, and the computer-readable storage medium is loaded and run by a processor so as to enable a computer to realize the method for detecting the axial pipe stress based on the OAE according to claim 11.
